(19) United States
(12) Patent Application Publication
(10) Pub. No.: US 2008/0268776 A1
(43) Pub. Date: Oct. 30, 2008

(54) Method and Apparatus for Secure Pairing of Bluetooth Devices

(75) Inventor: Raffaele G. Amendola, West Chicago, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/739,943

(22) Filed: Apr. 25, 2007

(51) Int. Cl. H04B 7/00

(52) U.S. Cl. 455/41.2

(57) ABSTRACT

Embodiments of the invention generally provide a method and apparatus for secure pairing of Bluetooth devices that supports the detection of man-in-the-middle attacks. One embodiment of a method for pairing a first Bluetooth device and a second Bluetooth device includes sending, by the first Bluetooth device, a series of audio tones to the second Bluetooth device, comparing the series of audio tones to a verification value computed by the second Bluetooth device and pairing with the second Bluetooth device if the verification value corresponds to the series of audio tones. Another embodiment of a method for pairing a first Bluetooth device and a second Bluetooth device includes receiving, at the second Bluetooth device, a series of audio tones from the first Bluetooth device, comparing the series of audio tones to a first verification value computed by the second Bluetooth device and pairing with the first Bluetooth device if the series of audio tones corresponds to the first verification value.

### FIELD OF THE INVENTION

The present invention generally relates to wireless communications, and more particularly relates to the Bluetooth communications protocol.

### BACKGROUND OF THE INVENTION

Bluetooth “pairing” is a term that refers to the formation of a trusted pair by two Bluetooth-enabled devices. Bluetooth devices that form a trusted pair may automatically accept communications from each other (i.e., without the need to establish new authentication material for each communication). The Bluetooth standards group has proposed several new methods for pairing Bluetooth devices. These pairing methods fall under the Secure Simple Pairing designation. The Secure Simple Pairing feature is intended to better protect the Bluetooth pairing process against passive eavesdropping attacks and man-in-the-middle (MITM) attacks. A MITM attack is one in which an unauthorized entity interjects itself into the communication flow between two legitimate devices and forces communication traffic to be routed through the unauthorized device. Potential consequences of a MITM attack include unauthorized disclosure or modification of information and attainment of unauthorized privileges on a device.

The Secure Simple Pairing methods combine Elliptic Curve Diffie-Hellman cryptography with other safeguards in order to provide increased security. For example, in the “Just Works” and “Numeric Comparison” pairing methods, pseudo-random values and public key information are used to cryptographically compute a numeric value (i.e., as defined by the Secure Simple Pairing protocol). Some such pairing methods allow the numeric values computed by the pairing devices to be compared by visually displaying the computed numeric values on the pairing devices. If the values match, then the users of the pairing devices can be reasonably certain that the process was not compromised by a MITM attack. However, these methods are limited to use in cases where both pairing devices have an extended user interface such as a visual display; devices such as Bluetooth headsets, which typically have limited user interfaces (i.e., do not include visual displays), cannot take advantage of these safeguards.

Therefore, there is a need in the art for a method and apparatus for secure pairing of Bluetooth devices that supports the detection of man-in-the-middle attacks, even against devices having limited user interfaces.

### BRIEF DESCRIPTION OF THE DRAWINGS

So that the manner in which the above recited embodiments of the invention are attained and can be understood in detail, a more particular description of the invention may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating two exemplary Bluetooth devices;

FIG. 2 is a flow diagram illustrating one embodiment of a method for pairing Bluetooth devices;

FIG. 3 is a flow diagram illustrating one embodiment of a method for pairing Bluetooth devices;

FIG. 4 is a flow diagram illustrating one embodiment of a method for pairing Bluetooth devices;

FIG. 5 is a flow diagram illustrating one embodiment of a method for pairing Bluetooth devices; and

FIG. 6 is a high level block diagram of the present Bluetooth pairing method that is implemented using a general purpose computing device.

To facilitate understanding, identical reference numerals have been used, where possible, to designate identical elements that are common to the figures.

### DETAILED DESCRIPTION

Embodiments of the invention generally provide a method and apparatus for secure pairing of Bluetooth devices. For instance, a user may want to pair his/her Bluetooth capable mobile phone with a Bluetooth capable headset. Embodiments of the invention support the detection of man-in-the-middle attacks, even against devices having limited user interfaces, by using audio tones to transmit a computed verification value from a first Bluetooth device (having a limited user interface) to a second Bluetooth device (which does not necessarily have a limited user interface).

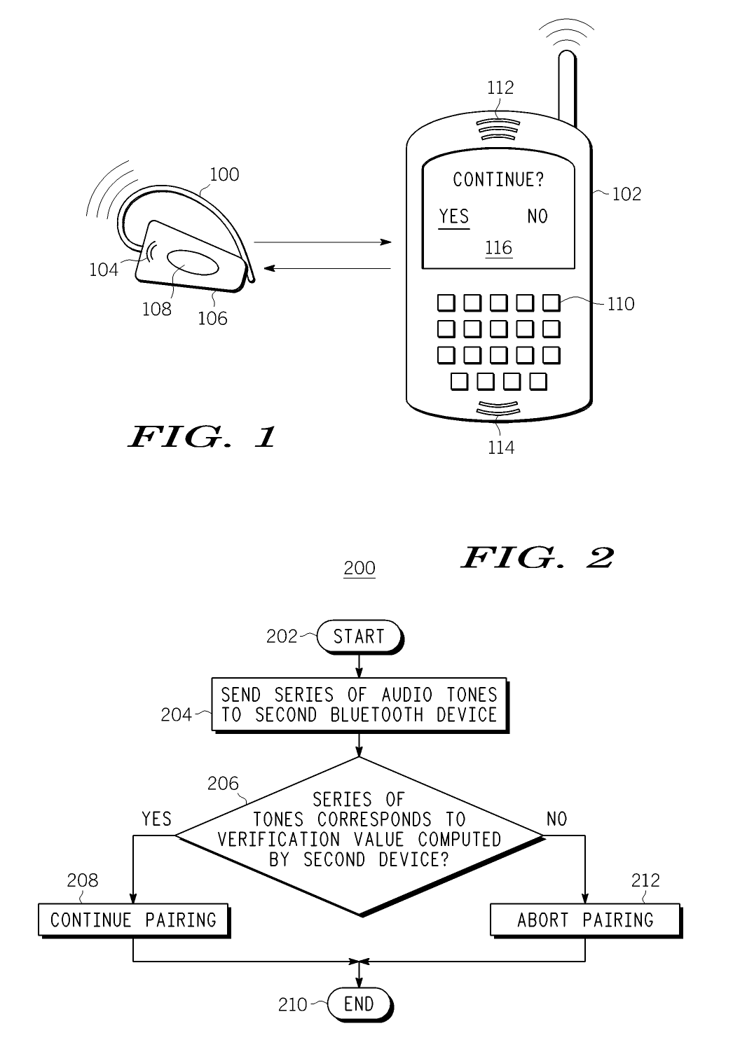

FIG. 1 is a schematic diagram illustrating two exemplary Bluetooth devices 100 and 102. Specifically, FIG. 1 depicts a first Bluetooth device 100 and a second Bluetooth device 102.

As illustrated, the first Bluetooth device 100 has a limited user interface. For the purposes of the present invention, a “limited user interface” is defined as a user interface that does not include a visual display (e.g., such as the user interface on a Bluetooth capable headset). For example, the exemplary first Bluetooth device 100 is a Bluetooth capable headset that includes a speaker 104, a microphone 106 and an on/off button 108.

By contrast, the exemplary second Bluetooth device 102 is a Bluetooth capable mobile phone that includes a speaker 112, a microphone 114, a keypad 110 (e.g., a qwerty or numeric keypad) and a visual display 116.

FIG. 2 is a flow diagram illustrating one embodiment of a method 200 for pairing Bluetooth devices. The method 200 may be implemented, for example, at a first Bluetooth device that is attempting to pair securely with a second Bluetooth device. In one embodiment, at least the first Bluetooth device is a device having a limited user interface (e.g., such as the first Bluetooth device 100 illustrated in FIG. 1).

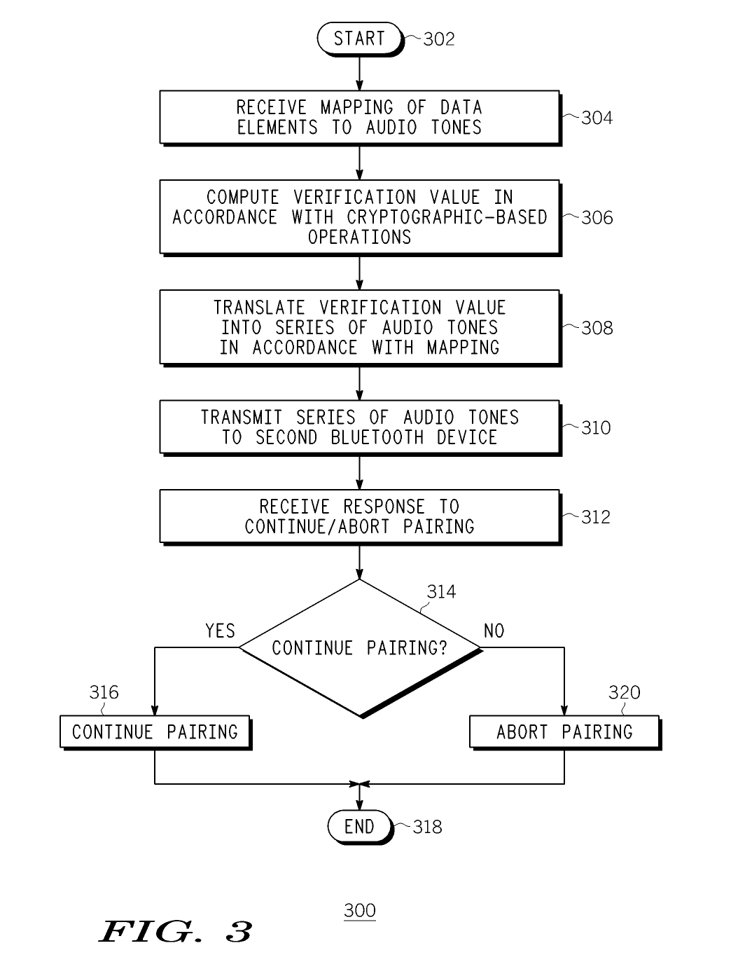

The method 200 is initialized at step 202 and proceeds to step 204, where the first Bluetooth device sends a series of audio tones over an audio channel to the second Bluetooth device. As will be described in further detail below with respect to FIG. 3, the series of audio tones represents a verification value (e.g., a numeric value as defined by the Secure Simple Pairing protocol). The first Bluetooth device then determines in step 206 whether the series of tones sent to the second Bluetooth device corresponds to a verification value (e.g., a numeric value as defined by the Secure Simple Pairing protocol) independently computed by the second Bluetooth device. In one embodiment, this determination is made in accordance with a confirmation from the second Bluetooth device (e.g., sent from the second Bluetooth device to the first Bluetooth device in the form of a message over an out-of-band channel such as an audio channel) that the series of tones and the verification value correspond.

If the first Bluetooth device concludes in step 206 that the series of tones corresponds to the verification value, the first Bluetooth device proceeds to step 208 and continues the pairing process with the second Bluetooth device. Alternatively, if the first Bluetooth device concludes in step 206 that the series of tones does not correspond to the verification value, the first Bluetooth device proceeds to step 212 and aborts the pairing process. The method 200 then terminates in step 210.

The method 200 therefore allows a Bluetooth device having a limited user interface to establish a secure pairing, with safeguards to help detect and therefore protect against both passive eavesdropping attacks and MITM attacks, with another Bluetooth device.

FIG. 3 is a flow diagram illustrating one embodiment of a method 300 for pairing Bluetooth devices. Specifically, the method 300 provides a more in depth description of the high-level method described with respect to FIG. 2. Like the method 200, the method 300 may be implemented, for example, at a first Bluetooth device that is attempting to pair securely with a second Bluetooth device. In one embodiment, at least the first Bluetooth device is a device having a limited user interface (e.g., such as the first Bluetooth device 100 illustrated in FIG. 1).

The method 300 is initialized at step 302 and proceeds to step 304, where the first Bluetooth device receives (or retrieves from memory, e.g., a hard drive, a network file system or the like) a mapping of data elements (e.g., digits or combinations of digits) to audio tones. In one embodiment, each element (e.g., an alphanumeric value or symbol) that can possibly be used in a verification value for pairing purposes has a mapping to a defined set of audible frequencies. Thus, for example, in a base-10 system, there will be ten possible numeric values corresponding to ten audio tones. In a further embodiment, additional audio tones are defined as control signals (e.g., to indicate the start and/or end of a transmission, to abort the pairing process, to send an acknowledgement, to indicate a successful match, etc.). In one embodiment, the mapping is pre-programmed or hardwired into the first device. In another embodiment, the mapping is transmitted to the first device from another device (e.g., from the second device). In another embodiment still, there may be more than one mapping available for the first Bluetooth device to receive or retrieve from memory.

In step 306, the first Bluetooth device computes a verification value. In one embodiment, cryptographic-based operations are used to compute the verification value. In another embodiment, the verification value is computed without the aid of cryptography. In a further embodiment, the verification value is computed in accordance with data exchanged or generated during an initial data exchange with the second Bluetooth device. The first Bluetooth device then proceeds to step 308 and translates the verification value computed in step 306 into a series of audio tones, in accordance with the mapping received in step 304.

In step 310, the first Bluetooth device transmits the series of audio tones to the second Bluetooth device, over an audio channel. In step 312, the first Bluetooth device then receives a response (e.g., from the second Bluetooth device over an out-of-band channel or from the user) indicating whether to continue or abort the pairing process. In one embodiment, where the pairing process is automated, the response received in step 312 comprises an out-of-band (e.g., not over the Bluetooth channel) response that indicates whether or not the second Bluetooth device wishes to continue the pairing process. For instance, in one embodiment, the response is an audio response received over the audio channel. In one embodiment, the audio response comprises a second set of audio tones, where the second set of audio tones is one of at least two possible sets of tones (e.g., one set of tones indicating that the verification value computed in step 306 matches a verification value computed independently by the second Bluetooth device, and one set of tones indicating that the verification value computed in step 306 does not match a verification value computed independently by the second Bluetooth device).

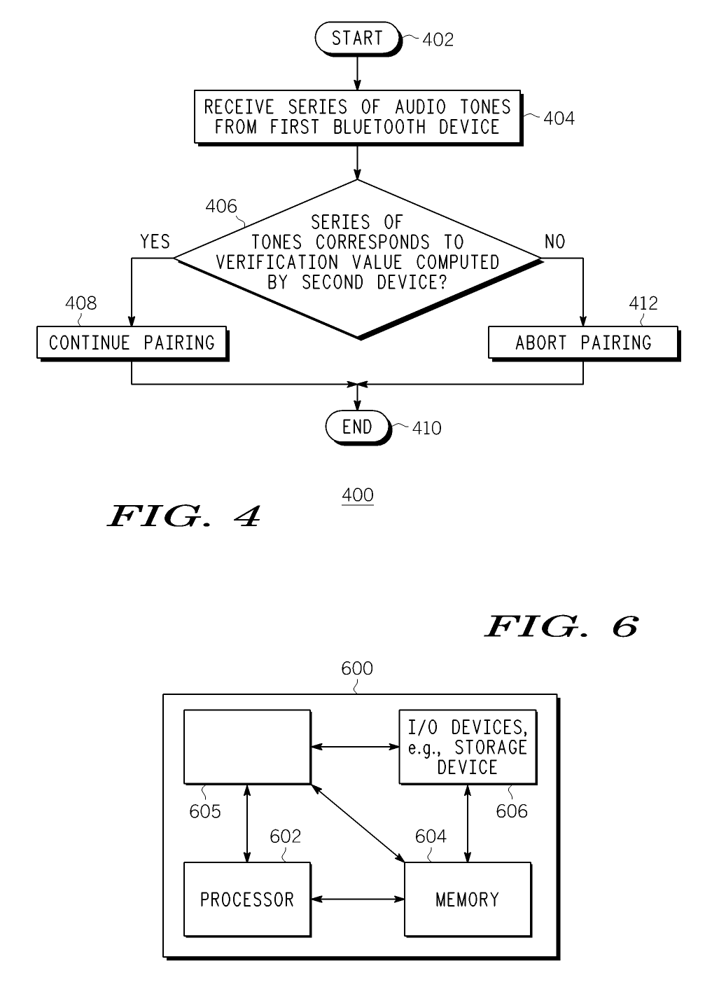

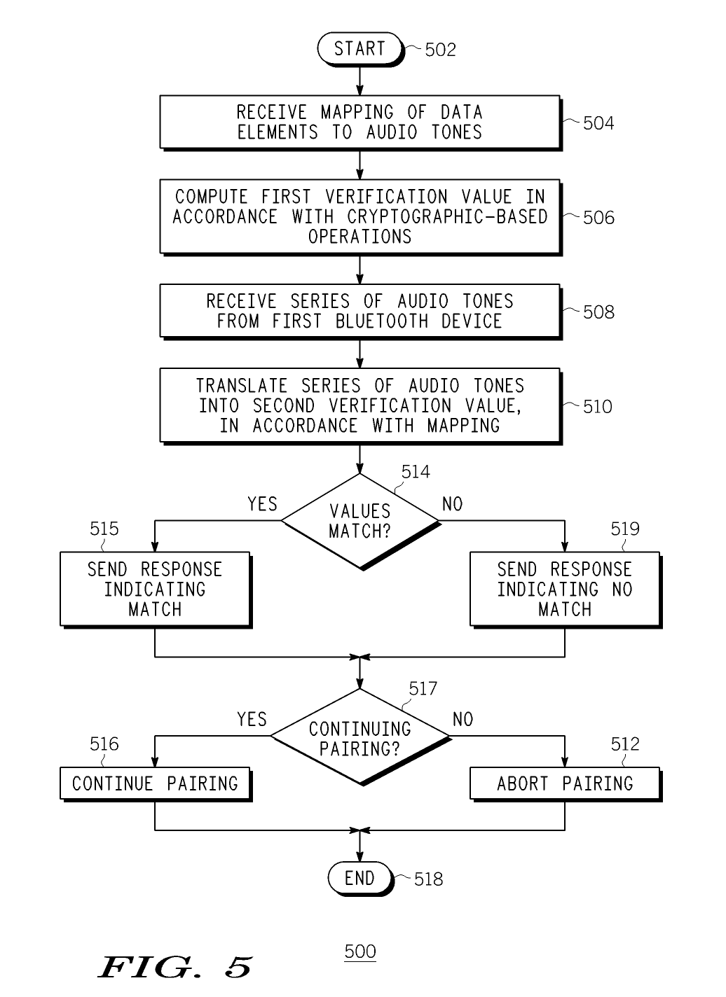

In one embodiment, the second Bluetooth device will indicate willingness to continue the pairing process if the verification value corresponding to the series of tones sent in step 310 (i.e., the verification value computed in step 306) matches a verification value computed independently by the second Bluetooth device, as described in greater detail with respect to FIGS. 4 and 5).

In another embodiment, where the pairing process is not continued without some sort of user affirmation or approval, the response received in step 312 involves a prompt to which a user must respond in order to continue or abort the pairing process. For example, the second Bluetooth device may display a message to the user on the device display, such as “SUCCESSFUL MATCH: CONTINUE? YES/NO” (see, for example, the display 116 in FIG. 1). In this case, the response received in step 312 is the selection (YES or NO) made by the user of the second Bluetooth device (e.g., by pressing a button or by issuing a voice command).

In step 314, the first Bluetooth device determines whether to continue pairing with the second Bluetooth device. As described with respect to step 312, this decision may be automated based on an out-of-band response from the second Bluetooth device (e.g., received over a channel other than the Bluetooth channel), or the decision may rely on some sort of indication from the user. For instance, in one embodiment, the response is an audio response received over the audio channel.

If the first Bluetooth device concludes in step 314 that the pairing process should continue, the first Bluetooth device proceeds to step 316 and continues the pairing process with the second Bluetooth device. The first Bluetooth device and the second Bluetooth device can now be reasonably assured that this phase of the pairing process has been completed securely. Alternatively, if the first Bluetooth device concludes in step 314 that the connection has been declined by the second Bluetooth device, the first Bluetooth device proceeds to step 320 and aborts the pairing process. The method 300 then terminates in step 318.

FIG. 4 is a flow diagram illustrating one embodiment of a method 400 for pairing Bluetooth devices. The method 400 may be implemented, for example, at the second Bluetooth device in the above examples (i.e., the Bluetooth device that is attempting to pair securely with the first Bluetooth device). In one embodiment, at least the first Bluetooth device is a device having a limited user interface (e.g., such as the first Bluetooth device 100 illustrated in FIG. 1).

The method 400 is initialized at step 402 and proceeds to step 404, where the second Bluetooth device receives, over an audio channel, a series of audio tones from the first Bluetooth device. As described above, the series of audio tones represents a verification value. The second Bluetooth device then determines in step 406 whether the series of tones received from the first Bluetooth device corresponds to a verification value independently computed by the second Bluetooth device.

If the second Bluetooth device concludes in step 406 that the series of tones corresponds to the verification value, the second Bluetooth device proceeds to step 408 and continues the pairing process with the first Bluetooth device. Alternatively, if the second Bluetooth device concludes in step 406 that the series of tones does not correspond to the verification value, the second Bluetooth device proceeds to step 412 and aborts the pairing process. The method 400 then terminates in step 410.

FIG. 5 is a flow diagram illustrating one embodiment of a method 500 for pairing Bluetooth devices. Specifically, the method 500 provides a more in depth description of the high-level method described with respect to FIG.4. Like the method 400, the method 500 may be implemented, for example, at the second Bluetooth device in the above examples. In one embodiment, at least the first Bluetooth device is a device having a limited user interface (e.g., such as the first Bluetooth device 100 illustrated in FIG. 1).

The method 500 is initialized at step 502 and proceeds to step 504, where the second Bluetooth device receives (or retrieves from memory, e.g., a hard drive, a network file system or the like) a mapping of data elements (e.g., digits or combinations of digits) to audio tones. In one embodiment, each element that can possibly be used in a verification value for pairing purposes has a mapping to a defined set of audible frequencies. In a further embodiment, additional audio tones are defined as control signals (e.g., to indicate the start and/or end of a transmission, to abort the pairing process, to send an acknowledgement, to indicate a successful match, etc.).

In step 506, the second Bluetooth device computes a first verification value, for example in accordance with cryptographic-based operations. In another embodiment, the verification value is computed without the aid of cryptography. In a further embodiment, the verification value is computed in accordance with data exchanged or generated during an initial data exchange with the first Bluetooth device. The second Bluetooth device then proceeds to step 508 and receives, over an audio channel, a series of audio tones from the first Bluetooth device. In step 510, the second Bluetooth device translates the series of audio tones received in step 508 into a second verification value, in accordance with the mapping received in step 504.

In step 514, the second Bluetooth device determines whether the second verification value (corresponding to the series of tones received in step 508) matches the first verification value (computed in step 506). If the second Bluetooth device concludes in step 514 that the second verification value matches the first verification value, the second Bluetooth device proceeds to step 515 and sends a response to the first Bluetooth device (e.g., over the audio channel) or to the user indicating the match. As described above in one embodiment, the response is an out-of-band (e.g., not sent over the Bluetooth channel) response that facilitates an automated pairing process. For instance, in one embodiment, the response is an audio response sent over the audio channel. In another embodiment, the response is a prompt requiring a response from the user in order to continue or abort the pairing process.

Alternatively, if the second Bluetooth device concludes in step 514 that the second verification value does not match the first verification value, the second Bluetooth device proceeds to step 519 and sends a response to the first Bluetooth device (e.g., over the audio channel) or to the user indicating no match. As described above in one embodiment, the response is an out-of-band (e.g., not sent over the Bluetooth channel) response that facilitates an automated pairing process, such as a second set of audio tones. In another embodiment, the response is a prompt requiring a response from the user (e.g., a button press or voice command) in order to continue or abort the pairing process.

In step 517, the second Bluetooth device determines whether to continue the pairing process. In one embodiment, a decision to continue (or abort) the pairing process is made based on a prompted response from the user or on an automated protocol. If the second Bluetooth device concludes in step 517 that the pairing process should continue, the second Bluetooth device proceeds to step 516 and continues the pairing process. The first Bluetooth device and the second Bluetooth device can now be reasonably assured that this phase of the pairing process has been completed securely.

Alternatively, if the second Bluetooth device concludes in step 517 that the pairing process should be aborted, the second Bluetooth device proceeds to step 512 and aborts the pairing process (thus, no pairing results). The method 500 then terminates in step 518.

FIG. 6 is a high level block diagram of the present Bluetooth pairing method that is implemented using a general purpose computing device 600. In one embodiment, a general purpose computing device 600 comprises a processor 602, a memory 604, a Bluetooth pairing module 605 and various input/output (I/O) devices 606 such as a display, a keyboard, a mouse, a modem, a microphone, a speaker, a network connection and the like. In one embodiment, at least one I/O device is a storage device (e.g., a disk drive, flash memory, an optical disk drive, a floppy disk drive). It should be understood that the Bluetooth pairing module 605 can be implemented as a physical device or subsystem that is coupled to a processor through a communication channel.

Alternatively, the Bluetooth pairing module 605 can be represented by one or more software applications (or even a combination of software and hardware, e.g., using Application-Specific Integrated Circuits (ASIC)), where the software is loaded from a storage medium (e.g., I/O devices 606) and operated by the processor 602 in the memory 604 of the general purpose computing device 600. Additionally, the software may run in a distributed or partitioned fashion on two or more computing devices similar to the general purpose computing device 600. Thus, in one embodiment, the Bluetooth pairing module 605 for supporting detection of man-in-the-middle attacks described herein with reference to the preceding figures can be stored on a computer readable medium or carrier (e.g., RAM, magnetic or optical drive or diskette, and the like).

Thus, the present invention represents a significant advancement in the field of wireless communications. Embodiments of the invention support the detection of man-in-the-middle attacks, even against devices having limited user interfaces, by using audio tones to transmit a computed verification value from a first Bluetooth device (having a limited user interface) to a second Bluetooth device (which does not necessarily have a limited user interface) and enabling the comparison of the transmitted value to a value computed independently by the second Bluetooth device. The present invention can thus be considered as an enhancement to the “Just Works” method used in the pairing process for Bluetooth devices. The present invention may also be implemented in other methods, such as the “Numeric Comparison” method, in order to automate the comparison of the computed verification values.

While the foregoing is directed to embodiments of the invention, other and further embodiments of the invention may be devised without departing from the basic scope thereof.

What is claimed is:

1. A computer readable medium containing an executable program for pairing a first Bluetooth device and a second Bluetooth device, where the program performs:
sending, by the first Bluetooth device, a series of audio tones to the second Bluetooth device;
comparing the series of audio tones to a first verification value computed by the second Bluetooth device; and
pairing with the second Bluetooth device if the first verification value corresponds to the series of audio tones.

2. The computer readable medium of claim 1, wherein at least the first Bluetooth device includes a limited user interface.

3. The computer readable medium of claim 1, wherein the sending comprises:
computing a second verification value; and
translating the second verification value into the series of audio tones.

4. The computer readable medium of claim 3, wherein a mapping provides an audio tone mapped to each data element.

5. The computer readable medium of claim 4, wherein the mapping further includes at least one audio tone mapped to a control signal.

6. The computer readable medium of claim 1, wherein the first verification value and the second verification value are numeric values as defined by the Secure Simple Pairing documentation.

7. A computer readable medium containing an executable program for pairing a first Bluetooth device and a second Bluetooth device, where the program performs the steps of:
receiving, at the second Bluetooth device, a series of audio tones from the first Bluetooth device;
comparing the series of audio tones to a first verification value computed by the second Bluetooth device; and
pairing with the first Bluetooth device if the series of audio tones corresponds to the first verification value.

8. The computer readable medium of claim 7, wherein at least the first Bluetooth device includes a limited user interface.

9. The computer readable medium of claim 7, further comprising:
translating the series of audio tones into a second verification value, in accordance with a mapping of data elements to audio tones.

10. The computer readable medium of claim 9, wherein the mapping further includes at least one audio tone mapped to a control signal.

11. The computer readable medium of claim 7, wherein the pairing comprises:
informing a user as to whether the series of audio tones corresponds to the first verification value; and
soliciting instruction from the user as to whether to continue a pairing process with the first Bluetooth device.

12. The computer readable medium of claim 7, wherein the first verification value and the second verification value are numeric values as defined by the Secure Simple Pairing documentation.

13. A system, comprising:
a first Bluetooth device for sending a series of audio tones; and
a second Bluetooth device for receiving the series of audio tones and for comparing a first verification value represented by the series of audio tones to a second verification value,
where the first Bluetooth device and the second Bluetooth are configured for pairing with each other if the first verification value matches the second verification value.

14. The system of claim 13, wherein at least the first Bluetooth device includes a limited user interface.

15. The system of claim 13, wherein the first Bluetooth device further comprises a processor for computing the first verification value and for translating the first verification value into the series of audio tones.

16. The system of claim 15, wherein a mapping provides an audio tone mapped to each data element that can possibly be used in the first verification value.

17. The system of claim 16, wherein the mapping further includes at least one audio tone mapped to a control signal.

18. The system of claim 13, wherein the first verification value and the second verification value are numeric values as defined by the Secure Simple Pairing documentation.

19. The system of claim 13, wherein the second Bluetooth device further comprises a processor for translating the series of audio tones into the first verification value, in accordance with a mapping of data elements to audio tones.

20. The system of claim 13, wherein the second Bluetooth device further comprises:
an interface for informing a user as to whether the first verification value matches the second verification value; and
an interface for soliciting instruction from the user as to whether to continue a pairing process with the first Bluetooth device.
